(19) United States
(12) Patent Application Publication
(10) Pub. No.: US 2021/0206955 A1
(43) Pub. Date: Jul. 8, 2021

(54) PEROXIDE CROSSLINKABLE FLUORORUBBER COMPOSITION

(71) Applicant: NOK CORPORATION, Tokyo (JP)

(72) Inventors: Hideto KOMURASAKI, Kumamoto (JP); Shingo KAWANO, Kumamoto (JP)

(73) Assignee: NOK CORPORATION, Tokyo (JP)

(21) Appl. No.: 17/056,790

(22) PCT Filed: May 29, 2019
(86) PCT No.: PCT/JP2019/021362

§ 371 Date: Nov. 19, 2020

(30) Foreign Application Priority Data
May 30, 2018 (JP) 2018-103594

(51) Int. Cl. C08L 27/16; C08L 27/18; C08L 27/20; C09K 3/10

(52) U.S. Cl. CPC C08L 27/16; C08L 27/18; C08L 27/20; C09K 2200/0657; C08L 2312/00; C08L 2205/03; C09K 2200/0642; C09K 3/1009

(57) ABSTRACT

A peroxide crosslinkable fluororubber composition comprising:
(A) 0.1 to 2.5 parts by weight of a sodium salt or potassium salt of a saturated or unsaturated higher fatty acid;
(B) (a) 0.1 to 3.5 parts by weight of a fluoropolyether derivative having a melting point of 70° C. or less,
   (b) 0.1 to 3.0 parts by weight of a poly-α-olefin oligomer, or
   (c) 0.1 to 2.0 parts by weight of an alkylamine compound having 4 to 30 carbon atoms; and
(C) 0.1 to 5 parts by weight of an organic peroxide,
   based on 100 parts by weight of peroxide crosslinkable fluororubber. This fluororubber composition has excellent crosslinking rate, mold release properties, hardness, compression set characteristics, and the like that are required for molding processability.

### TECHNICAL FIELD

The present disclosure relates to a peroxide crosslinkable fluororubber composition. More particularly, the present disclosure relates to a peroxide crosslinkable fluororubber composition having excellent crosslinking rate, mold release properties, hardness, compression set characteristics, and the like that are required for molding processability.

### BACKGROUND ART

Fluororubber is relatively expensive and has poor processability up to the molding process; thus, high processing cost is required. Various improvement efforts have been made to reduce the product cost.

As such an improvement method, selection to reduce the raw material cost so as to obtain effects directly is considered; however, it is difficult to reduce the cost with a satisfactory raw material quality. This method is not suitable for ensuring the quality of functional rubber parts.

On the other hand, there is a method of improving processability in order to reduce the cost in the production process. In particular, shortening the vulcanization time in the molding process, high mold release properties, and a reduction of burr formation, directly affect the productivity of products, and thus are expected to be effective in facilitating the cost reduction. Although such an improvement can be achieved by installing equipment, it is not easy because the equipment cost greatly affects the production cost. In many cases, an improvement is achieved by the compounding composition of rubber compounds.

As an improvement method with the compounding composition, there is a method of selecting a fluororubber polymer that is said to have good processability; however, it is difficult to sufficiently exhibit processability for unique production processes of rubber part manufacturers. An improvement method by adding a processing aid is required. There are various processing aids used in such a method; however, they each had different improvement effects, and it was thus difficult to sufficiently satisfy some types of required processability by adding them alone.

Further, silicone-based processing aids have a great effect of improving processability and are preferably used. However, they may be used in or near electronic parts depending on the use environment of products, and problematically cause contamination. For this reason, non-silicone-based processing aids have been increasingly demanded recently. Thus, in the actual circumstances, it is difficult to use silicone-based processing aids without careful consideration.

Patent Document 1 proposes a fluororubber composition comprising 0.8 to 4.0 parts by weight of a glycerol ester of an unsaturated fatty acid having 14 to 20 carbon atoms based on 100 parts by weight of fluororubber. Patent Document 1 indicate that this fluororubber composition can provide a crosslinked fluororubber article having exceptional surface smoothness while maintaining rubber properties such as strength.

However, as shown in the results of Comparative Example 12 provided later, when glycerol monooleate ester is compounded, the vulcanization rate, mold release properties, hardness difference, and compression set do not show desired results. Moreover, even when glycerol monooleate ester is used in combination with calcium stearate or beef tallow hardened fatty acid potassium (Comparative Examples 17 and 18), the vulcanization rate and hardness difference (and compression set) are not satisfied.

Patent Document 1 indicates that as processing aids other than glycerol esters, alkali metal salts and the like of higher fatty acids can be used as mold release property improving agent. In all of the Examples and Comparative Examples, a tetrafluoroethylene-propylene copolymer is used as fluororubber, and sodium stearate is also used as a processing aid for normal state physical properties and surface smoothness; however, calcium stearate is used in many examples.

In Comparative Example 5 provided later, in which calcium stearate is used alone, the vulcanization rate, O ring thickness, and hardness difference are not satisfied. In Comparative Example 17, in which calcium stearate is used in combination with glycerol monooleate ester, the vulcanization rate, hardness difference, and compression set are not satisfied, as described above.

### PRIOR ART DOCUMENT

### Patent Document

Patent Document 1: WO 2016/084862 A1

Patent Document 2: JP-A-2001-354986

### OUTLINE OF THE INVENTION

### Problem to be Solved by the Invention

An object of the present disclosure is to provide a peroxide crosslinkable fluororubber composition having excellent crosslinking rate, mold release properties, hardness, compression set characteristics, and the like that are required for molding processability.

### Means for Solving the Problem

The above object of the present disclosure can be achieved by a peroxide crosslinkable fluororubber composition comprising:

(A) 0.1 to 2.5 parts by weight of a sodium salt or potassium salt of a saturated or unsaturated higher fatty acid;

(B) (a) 0.1 to 3.5 parts by weight of a fluoropolyether derivative having a melting point of 70° C. or less,
(b) 0.1 to 3.0 parts by weight of a poly-α-olefin oligomer, or
(c) 0.1 to 2.0 parts by weight of an alkylamine compound having 4 to 30 carbon atoms; and

(C) 0.1 to 5 parts by weight of an organic peroxide, based on 100 parts by weight of peroxide crosslinkable fluororubber.

### Effect of the Invention

Due to the combined use of two types of processing aids (A) and (B), the peroxide crosslinkable fluororubber composition according to the present disclosure has excellent crosslinking rate, mold release properties, hardness, compression set characteristics, and the like that are required for molding processability, and can be thus effectively used as molding materials for various crosslinked and molded articles, particularly sealing materials.

### EMBODIMENTS FOR CARRYING OUT THE INVENTION

The peroxide crosslinkable fluororubber used is a copolymer of a fluorine-containing unsaturated monomer having an iodine atom and/or a bromine atom in a polymer main chain and/or side chain.

Examples of the fluorine-containing unsaturated monomer include tetrafluoroethylene, vinylidene fluoride, hexafluoropropylene, trifluoroethylene, chlorotrifluoroethylene, 1,1,3,3,3-pentafluoropropylene, perfluoro(methylvinyl ether), perfluoro(ethyl vinyl ether), perfluoro(propyl vinyl ether), and the like.

Examples of the peroxide crosslinkable fluororubber include a vinylidene fluoride-hexafluoropropylene copolymer, a vinylidene fluoride-tetrafluoroethylene-hexafluoropropylene terpolymer, a vinylidene fluoride-tetrafluoroethylene-perfluoro(methyl vinyl ether) terpolymer, a tetrafluoroethylene-ethylene-perfluoro(methyl vinyl ether) terpolymer, a tetrafluoroethylene-propylene copolymer, a vinylidene fluoride-propylene copolymer, a tetrafluoroethylene-vinylidene fluoride-propylene terpolymer, and the like.

In addition to the above fluorine-containing unsaturated monomers, a fluorine-containing unsaturated monomer for modifying the characteristics of fluororubber may be copolymerized at a ratio of 3 wt. % or less. Examples of the fluorine-containing unsaturated monomer for modifying the characteristics of fluororubber include fluorine-containing diene compounds, such as perfluoro(3,6-dioxa-1,7-octadiene), 3,3,4,4,5,5,6,6-octafluoro-1,7-octadiene, and 3,3,4,4,5,5,6,6,7,7,8,8,9,9,10,10-hexadecafluoro-1,9-decadiene.

Further, a non-fluorine unsaturated monomer, such as propylene or ethylene, may be copolymerized at a ratio of 30 wt. % or less.

It is preferable to use a copolymer elastomer in which an iodine group and/or a bromine group is introduced into a copolymer elastomer having a ternary or binary copolymer composition of about 50 to 80 mol % of vinylidene fluoride [VdF], about 15 to 50 mol % of hexafluoropropylene [HFP], and about 30 to 0 mol % of tetrafluoroethylene [TFE]. Moreover, cold resistant fluororubber, which is a perfluoroalkyl group-containing copolymer elastomer, super cold resistant fluororubber, which is a perfluoromethoxy vinyl ether-containing copolymer elastomer, and the like can also be used.

In practice, commercial products, such as Viton GAL200S, GBL200S, GBL600S, GF200S, and GF600S, produced by Du Pont; Tecnoflon P454, P757, P459, and P952, produced by Solvay Specialty Polymers; and DAI-EL G952, G901, G902, G912, and G801, produced by Daikin Industries, Ltd.; are used as they are.

An iodine atom and/or a bromine atom, which are crosslinking sites of the peroxide crosslinkable fluororubber, can be introduced into the polymer main chain terminal by carrying out the polymerization reaction in the presence of a fluorine-containing dihalogen compound, such as 1,4-diiodooctafluorobutane or 1-bromo-2-iodotetrafluoroethane. When monohalogeno fluorine-containing ethylene, such as 1-iodotrifluoroethylene, 1,1-difluoro-2-iodoethylene, or 1,1-difluoro-2-bromoethylene, is copolymerized, an iodine atom or a bromine atom can be introduced into the inside of the polymer main chain. When perfluoro(2-bromoethyl vinyl ether), 4-iodo-3,3,4,4-tetrafluoro-1-butene, or the like is copolymerized, an iodine atom or a bromine atom can be introduced into the polymer side chain.

Examples of the organic peroxide crosslinking agent, which is used to crosslink the peroxide crosslinkable fluororubber, include dialkyl peroxides, such as dicumyl peroxide, di-tert-butylperoxide, 2,5-dimethyl-2,5-di(tert-butylperoxy)hexyne-3, 2,5-dimethyl-2,5-di(tert-butylperoxy)hexane, and 1,3-bis(tert-butylperoxy isopropyl)benzene; diacyl peroxides, such as benzoyl peroxide and isobutyryl peroxide; peroxyesters, such as 2,5-dimethyl-2,5-bis(benzoylperoxy)hexane and tert-butylperoxy isopropyl carbonate; and the like. Among these, 2,5-dimethyl-2,5-di(tert-butylperoxy)hexane is preferable. These can be used singly or in combination of two or more.

The organic peroxide crosslinking agent is used at a ratio of about 0.1 to 5 parts by weight, preferably about 0.3 to 3 parts by weight, based on 100 parts by weight of the peroxide crosslinkable fluororubber. If the use ratio is less than this range, the crosslinking of the fluororubber is insufficient, which may lead to a reduction in the mechanical properties of the crosslinked product. In contrast, if the organic peroxide crosslinking agent is used at a ratio larger than this range, excessive crosslinking progresses, which may lead to a reduction in the physical properties, such as elongation of the crosslinked product.

A polyfunctional unsaturated compound, such as triallyl isocyanurate, is used as a crosslinking aid for the peroxide crosslinkable fluororubber. The compounding amount thereof is about 0.1 to 10 parts by weight, preferably about 1 to 5 parts by weight, based on 100 parts by weight of the peroxide crosslinkable fluororubber. If the use ratio is less than this range, crosslinking is insufficient, which may make the shape retention of the crosslinked product difficult, or may lead to a reduction in the mechanical properties of the crosslinked product. In contrast, if the polyfunctional unsaturated compound is used at a ratio larger than this range, improvement of various characteristics, such as mechanical properties and heat resistance, cannot be expected, which is uneconomical.

As the sodium salt or potassium salt of a saturated or unsaturated higher fatty acid of the processing aid (A), Na salts or K salts of higher fatty acids having 8 to 18 carbon atoms, such as stearic acid, palmitic acid, oleic acid, linolic acid, and linolenic acid, are used as they are. The higher fatty acid is preferably a higher fatty acid derived from oils and fats. The combined use of the processing aid (A) with a lower aliphatic monocarboxylic acid metal salt is also effective.

In practice, commercial products, such as NS-Soap produced by Kao Corporation, which is a beef tallow hardened fatty acid sodium salt, Nonsoul SK-1 produced by NOF Corporation, which is beef tallow hardened fatty acid potassium, and SS-40N produced by Kao Corporation, which is a higher fatty acid sodium salt, are used as they are.

The processing aid (A) is used at a ratio of about 0.1 to 2.5 parts by weight, preferably about 0.2 to 2.0 parts by weight, more preferably about 0.2 to 1.0 part by weight, based on 100 parts by weight of the peroxide crosslinkable fluororubber. If the compounding ratio is less than this range, the object of the present disclosure cannot be achieved. In contrast, if the processing aid (A) is compounded at a ratio larger than this range, the compression set characteristics is deteriorated.

When a mixture mainly comprising a lower aliphatic monocarboxylic acid metal salt having 1 to 5 carbon atoms, such as TE58A produced by Technical Processing, is used in combination, it is used at a ratio of about 0.1 to 2.0 parts by weight, preferably about 0.1 to 1.5 parts by weight, more preferably about 0.1 to 1.0 part by weight, based on 100 parts by weight of the peroxide crosslinkable fluororubber.

These higher fatty acid metal salt-based compounds increased the crosslinking rate and improved the mold release properties; however, the effect for flowability was low, and molded articles tended to have a large size. Therefore, it was still insufficient to easily adjust the balance among the crosslinking rate, flowability, and mold release properties.

In order to improve such a point, at least one of the following compounds (a), (b), and (c) is used as a processing aid (B) in combination with the processing aid (A).

As the fluoropolyether derivative of the processing aid (a), for example, one represented by the general formula:

RfO(CF₂O)ₚ(C₂F₄O)_{q}(C₃F₆O)ᵣRf

Rf: a lower perfluoroalkyl group having 1 to 5 carbon atoms (Patent Document 2) is used. In practice, commercial products, such as FPA1 produced by Solvay Specialty Polymers, are used as they are. As the processing aid (a), one having a melting point of about 70° C. or less is used. If a processing aid having a melting point higher than this range is used, it cannot be dispersed during the preparation of the composition, and dispersion may be insufficient. In particular, in the case of addition using an open roll, handling is difficult because the temperature is less likely to increase.

The processing aid (a) is used at a ratio of about 0.1 to 3.5 parts by weight, preferably about 0.2 to 2.5 parts by weight, more preferably about 0.2 to 2.0 parts by weight, based on 100 parts by weight of the peroxide crosslinkable fluororubber. If the compounding ratio is less than this range, the object of the present disclosure cannot be achieved. In contrast, if the processing aid (a) is compounded at a ratio larger than this range, the compression set characteristics is deteriorated.

As the poly-α-olefin oligomer of the processing aid (b), oligomers of α-olefins having 3 or more carbon atoms, preferably α-olefins having 3 to 16 carbon atoms, such as oligomers of homopolymers or copolymers of polypropylene and polybutene, are used. In practice, commercial products, such as Dyurasin 128 produced by INEOS, are used as they are.

The processing aid (b) is used at a ratio of about 0.1 to 3.0 parts by weight, preferably about 0.2 to 2.0 parts by weight, more preferably about 0.2 to 1.0 part by weight, based on 100 parts by weight of the peroxide crosslinkable fluororubber. If the compounding ratio is less than this range, the object of the present disclosure cannot be achieved. In contrast, if the processing aid (b) is compounded at a ratio larger than this range, the compression set characteristics is deteriorated.

As the alkylamine having 4 to 30 carbon atoms of the processing aid (c), for example, stearylamine, octadecylamine, or the like is used. In practice, commercial products, such as Farmin 80 produced by Kao Corporation and HT290 produced by ScHill+Seilacher, are used as they are.

The processing aid (c) is used at a ratio of about 0.1 to 2.0 parts by weight, preferably about 0.2 to 1.0 part by weight, more preferably about 0.2 to 0.5 parts by weight, based on 100 parts by weight of the peroxide crosslinkable fluororubber. If the compounding ratio is less than this range, the object of the present disclosure cannot be achieved. In contrast, if the processing aid (c) is compounded at a ratio larger than this range, the compression set characteristics is deteriorated.

The total amount of the processing aids (A) and (B) must be about 0.2 to 5.0 parts by weight, preferably about 0.3 to 3.5 parts by weight, more preferably about 0.5 to 2.0 parts by weight, based on 100 parts by weight of the peroxide crosslinkable fluororubber. If the compounding ratio is less than this range, the object of the present disclosure cannot be achieved. In contrast, if they are compounded at a ratio larger than this range, the compression set characteristics is deteriorated.

In addition to the above essential components, the peroxide crosslinkable fluororubber composition can be compounded with compounding agents that are generally used in the field of rubber processing. Examples of such compounding agents include inorganic fillers such as carbon black and silica, acid acceptors, crosslinking accelerators, light stabilizers, plasticizers, other processing aids, smoothing agents, pressure-sensitive adhesives, lubricants, flame retardants, antifungal agents, antistatic agents, coloring agents, silane coupling agents, crosslinking retardants, and the like. The compounding amounts of these compounding agents are not particularly limited within a range that does not inhibit the object and effect of the present disclosure, and they can be suitably compounded in amounts depending on the compounding purpose.

The peroxide crosslinkable fluororubber composition can be prepared by compounding peroxide crosslinkable fluororubber with processing aids (A) and (B), an organic peroxide crosslinking agent (C), a polyfunctional unsaturated compound crosslinking aid, and optionally compounding agents described above using a Banbury mixer, a pressurizing kneader, an open roll, or the like.

The prepared composition is generally crosslinked by press crosslinking (primary crosslinking). Hot press is generally performed at a temperature of about 140 to 200° C. at a pressure of about 0.2 to 15 MPa for about 5 to 60 minutes. When the primary crosslinking is further carried out by postcure (secondary crosslinking), the mechanical properties, compression set, etc., of the crosslinked product can be improved.

### EXAMPLES

The following describes the present disclosure with reference to Examples.

### Example 1

| | | |
|---|---|---|
| Peroxide crosslinkable VdF-TFE-HFP terpolymer | 100 | parts by weight |
| (Tecnoflon P757, produced by Solvay Specialty | | |
| Polymers) | | |
| Carbon black (N990, produced by Cancarb | 25 | parts by weight |
| Limited) | | |
| Triallyl isocyanurate (TAIC, produced by Nippon | 2.5 | parts by weight |
| Kasei Chemical Co., Ltd.) | | |
| Organic peroxide (Perhexa 25B, produced by | 0.5 | parts by weight |
| NOF Corporation) | | |
| Beef tallow hardened fatty acid potassium | 0.7 | parts by weight |
| (Nonsoul SK-1, produced by NOF Corporation) | | |
| Fluoropolyether derivative (FPA1, produced by | 0.7 | parts by weight |
| Solvay Specialty Polymers, melting point: 50 | | |
| to 60° C.) | | |

The above-mentioned components other than the organic peroxide were each kneaded using a 1 L kneader or an open roll at 100° C. or less for 10 to 30 minutes. Then, the organic peroxide was added and kneaded using a 1 L kneader or an open roll at 100° C. or less for 5 to 10 minutes, thereby producing an uncrosslinked rubber sheet through the open roll.

The uncrosslinked rubber sheet was subjected to press crosslinking (primary crosslinking) at 180° C. for 6 minutes and oven crosslinking (secondary crosslinking) at 230° C. for 24 hours, and measured or evaluated for each of the following items. An O ring for fixing was crosslinked and molded in the shape of the bearing number G25 according to JIS B2401-1: 2012 corresponding to ISO 3601-1: 2008.

Crosslinking time difference: a value obtained by subtracting the t90 value of the processing aid-free compounding (Comparative Example 1) from the t90 value of each Example or each Comparative Example was calculated as the crosslinking time difference.

When the value was less than −10 seconds, it was effective to increase the crosslinking rate, which was evaluated as ◯.

When the value was −10 seconds or more, it delayed or was less effective to increase the crosslinking rate, which was evaluated as X.

G25 O ring outer diameter thickness: the average value of N=3 was calculated.

An O ring outer diameter thickness of 3.1±0.03 mm was evaluated as ◯.

An O ring outer diameter thickness outside the above range was evaluated as X.

G25 O ring mold release properties: The mold release properties of the O ring during compression press molding in a mold with 2×5 cavities mold in the G25 shape were evaluated.

When the O ring was integrally released with less resistance, and no cut lines occurred between the product and burrs, this case was evaluated as ◯.

When burrs were cut during mold release, or residues were formed in the mold, this case was evaluated as X.

Hardness difference (Shore A instantaneous value): According to JIS K6253: 2012 corresponding to ISO 7619-1: 2010

The difference from the value of the processing aid-free compounding (Comparative Example 1) was calculated.

A difference of less than +3 points was evaluated as ◯.

A difference of +3 points or more was evaluated as X.

Compression set: The O ring in the G25 shape after primary crosslinking (before secondary crosslinking) (according to JIS K2401-1: 2012 corresponding to ISO 3601-1: 2008) was cut at two points to prepare a semi-circular sample having a thickness of about 3.1 mm. The sample was sandwiched between SUS plates and put into an oven at 175° C. in a 25% compressed state. Immediately after heating for 70 hours, the sample was released from the SUS plates and allowed to stand under room temperature conditions for 30 minutes. Then, from the changes in the outer diameter thickness before and after the test, the compression set value was calculated as the difference from the processing aid-free compounding (Comparative Example 1) (according to JIS K6262: 2013 corresponding to ISO 815-1: 2008 and ISO 815-2: 2008).

A numerical value of +3 or less was evaluated as ◯.

A numerical value of more than +3 was evaluated as X.

### Example 2

In Example 1, of the compounded processing aids (fatty acid potassium-fluoropolyether derivative), the fluoropolyether derivative was changed to the same amount (0.7 parts by weight) of poly-α-olefin oligomer (Dyurasin 128, produced by INEOS).

### Example 3

In Example 1, of the compounded processing aids (fatty acid potassium-fluoropolyether derivative), the amount of the fluoropolyether derivative was changed to 0.5 parts by weight, and 0.2 parts by weight of aliphatic monocarboxylic acid metal salt mixture (TE58A, produced by Technical Processing), 0.5 parts by weight of beef tallow hardened fatty acid sodium salt (NS-Soap, produced by Kao Corporation), and 0.2 parts by weight of fatty acid sodium salt (SS-40N, produced by Kao Corporation) were used as fatty acid metal salt-based compounds.

### Example 4

In Example 1, of the compounded processing aids (fatty acid potassium-fluoropolyether derivative), 0.5 parts by weight of fatty acid sodium salt (SS-40N) was used in place of the beef tallow hardened fatty acid potassium, and 0.5 parts by weight of octadecylamine-containing mixture (HT290, produced by ScHill+Seilacher) was used in place of the fluoropolyether derivative.

### Example 5

In Example 1, the compounded processing aids (fatty acid potassium-fluoropolyether derivative) were changed to 0.7 parts by weight of fatty acid sodium salt (SS-40N) and 0.3 parts by weight of stearylamine (Farmin 80, produced by Kao Corporation).

### Comparative Example 1

In Example 1, the processing aid was not used.

### Comparative Examples 2 to 16

In Example 1, only following one kind was used in an amount of 1.4 parts by weight as the processing aid.

Comparative Example 2: Aliphatic Monocarboxylic Acid Metal Salt Mixture (TE58A)

Comparative Example 3: Beef tallow hardened fatty acid sodium salt (NS-Soap)

Comparative Example 4: Beef tallow hardened fatty acid potassium (Nonsoul SK-1)

Comparative Example 5: Fatty acid calcium salt (St-Ca, produced by Showa Chemical Industry Co., Ltd.)

Comparative Example 6: Alkylbenzenesulfonic acid sodium salt (DBS-NA, produced by Takemoto Oil & Fat Co., Ltd.)

Comparative Example 7: Fatty acid sodium salt (SS-40N)

Comparative Example 8: Stearic acid (produced by Miyoshi Oil & Fat Co., Ltd.)

Comparative Example 9: Fatty acid amide (Diamid 0-200, produced by Nippon Kasei Co., Ltd.)

Comparative Example 10: Fatty acid ester (VPA #2, produced by Chemours)

Comparative Example 11: Pentaerythritol tetrastearate (Deoflow 821, produced by DOG Chemie)

Comparative Example 12: Glycerol monooleate ester (a mixture of Emaster 510P, produced by Riken Vitamin Co., Ltd. and silica)

Comparative Example 13: Fluoropolyether derivative (FPA1)

Comparative Example 14: Poly-α-olefin oligomer (Dyurasin 128)

Comparative Example 15: Octadecylamine-containing mixture (HT290)

Comparative Example 16: Stearylamine (Farmin 80)

### Comparative Example 17

In Example 1, the compounded processing aids (fatty acid potassium-fluoropolyether derivative) were changed to 1.0 part by weight of fatty acid calcium salt (St-Ca) and 1.5 parts by weight of glycerol monooleate ester (Emaster 510P), respectively.

### Comparative Example 18

In Example 1, the compounded processing aids (fatty acid potassium-fluoropolyether derivative) were changed to 1.0 part by weight of beef tallow hardened fatty acid potassium (Nonsoul SK-1) and 1.5 parts by weight of glycerol monooleate ester (Emaster 510P), respectively.

### Comparative Example 19

In Example 1, the compounded processing aids (fatty acid potassium-fluoropolyether derivative) were changed to 0.7 parts by weight of fatty acid calcium salt (St-Ca) and 0.7 parts by weight of fluoropolyether derivative (FPA1), respectively.

### Comparative Example 20

In Example 1, the compounded processing aids (fatty acid potassium-fluoropolyether derivative) were changed to 0.7 parts by weight of beef tallow hardened fatty acid sodium salt (NS-Soap) and 0.7 parts by weight of fatty acid ester (VPA #2), respectively.

### Comparative Example 21

In Example 1, the compounded processing aids (fatty acid potassium-fluoropolyether derivative) were changed to 0.7 parts by weight of fatty acid sodium salt (SS-40N) and 0.7 parts by weight of fatty acid ester (VPA #2), respectively.

### Comparative Example 22

In Example 1, the compounded processing aids (fatty acid potassium-fluoropolyether derivative) were changed to 0.7 parts by weight of fatty acid sodium salt (SS-40N) and 0.7 parts by weight of pentaerythritol tetrastearate (Deoflow 821), respectively.

Following Table shows the results obtained respectively in the above Examples and Comparative Examples.

TABLE

| | | | | | O ring | | | | |
|---|---|---|---|---|---|---|---|---|---|
| | Crosslinking | | O ring | | Mold | Hardness | | Compression | |
| | time difference | | Thickness | | release | difference | | set | |
| Example | Second | Evaluation | (mm) | Evaluation | properties | Points | Evaluation | % | Evaluation |
| Example 1 | −19 | ◯ | 3.10 | ◯ | ◯ | 1 | ◯ | 1 | ◯ |
| Example 2 | −18 | ◯ | 3.10 | ◯ | ◯ | 2 | ◯ | 2 | ◯ |
| Example 3 | −12 | ◯ | 3.12 | ◯ | ◯ | 2 | ◯ | 2 | ◯ |
| Example 4 | −16 | ◯ | 3.12 | ◯ | ◯ | 2 | ◯ | 2 | ◯ |
| Example 5 | −17 | ◯ | 3.12 | ◯ | ◯ | 2 | ◯ | 2 | ◯ |
| Comparative | 120 | — | 3.20 | X | X | (70) | — | (19) | — |
| Example 1 | | | | | | | | | |
| Comparative | 13 | X | 3.10 | ◯ | ◯ | 4 | X | 2 | ◯ |
| Example 2 | | | | | | | | | |
| Comparative | −15 | ◯ | 3.15 | X | ◯ | 3 | X | 1 | ◯ |
| Example 3 | | | | | | | | | |
| Comparative | −25 | ◯ | 3.14 | X | ◯ | 3 | X | 4 | X |
| Example 4 | | | | | | | | | |
| Comparative | −3 | X | 3.17 | X | ◯ | 3 | X | 2 | ◯ |
| Example 5 | | | | | | | | | |
| Comparative | −11 | ◯ | 3.16 | X | X | 1 | ◯ | 10 | X |
| Example 6 | | | | | | | | | |
| Comparative | −23 | ◯ | 3.16 | X | ◯ | 2 | ◯ | 2 | ◯ |
| Example 7 | | | | | | | | | |
| Comparative | 10 | X | 3.11 | ◯ | X | 2 | ◯ | 11 | X |
| Example 8 | | | | | | | | | |
| Comparative | 60 | X | 3.08 | ◯ | X | 4 | X | 16 | X |
| Example 9 | | | | | | | | | |
| Comparative | −2 | X | 3.10 | ◯ | X | 4 | X | 2 | ◯ |
| Example 10 | | | | | | | | | |
| Comparative | ±0 | X | 3.10 | ◯ | X | 2 | ◯ | 2 | ◯ |
| Example 11 | | | | | | | | | |
| Comparative | 30 | X | 3.12 | ◯ | X | 4 | X | 7 | X |
| Example 12 | | | | | | | | | |
| Comparative | 1 | X | 3.12 | ◯ | X | ±0 | ◯ | 2 | ◯ |
| Example 13 | | | | | | | | | |
| Comparative | 6 | X | 3.09 | ◯ | X | 3 | X | 1 | ◯ |
| Example 14 | | | | | | | | | |
| Comparative | −10 | X | 3.09 | ◯ | X | 5 | X | 5 | X |
| Example 15 | | | | | | | | | |
| Comparative | −14 | ◯ | 3.13 | ◯ | ◯ | 5 | X | 10 | X |
| Example 16 | | | | | | | | | |
| Comparative | 20 | X | 3.12 | ◯ | ◯ | 7 | X | 6 | X |
| Example 17 | | | | | | | | | |
| Comparative | 0 | X | 3.10 | ◯ | ◯ | 6 | X | 2 | ◯ |
| Example 18 | | | | | | | | | |
| Comparative | −7 | X | 3.15 | X | ◯ | 1 | ◯ | 1 | ◯ |
| Example 19 | | | | | | | | | |
| Comparative | −15 | ◯ | 3.11 | ◯ | ◯ | 3 | X | 1 | ◯ |
| Example 20 | | | | | | | | | |
| Comparative | −17 | ◯ | 3.11 | ◯ | ◯ | 3 | X | 1 | ◯ |
| Example 21 | | | | | | | | | |
| Comparative | −10 | X | 3.11 | ◯ | ◯ | 2 | ◯ | 1 | ◯ |
| Example 22 | | | | | | | | | |

1. A peroxide crosslinkable fluororubber composition comprising:
(A) 0.1 to 2.0 parts by weight of a sodium salt or potassium salt of a saturated or unsaturated higher fatty acid;
(B) (a) 0.1 to 2.5 parts by weight of a fluoropolyether derivative having a melting point of 70° C. or less,
(b) 0.1 to 2.0 parts by weight of a poly-α-olefin oligomer, or
(c) 0.1 to 1.0 parts by weight of an alkylamine compound having 4 to 30 carbon atoms; and
(C) 0.1 to 5 parts by weight of an organic peroxide,
based on 100 parts by weight of peroxide crosslinkable fluororubber having an iodine atom and/or a bromine atom in a polymer main chain and/or side chain.

2. The peroxide crosslinkable fluororubber composition according to claim 1, wherein the peroxide crosslinkable fluororubber is a copolymer elastomer in which an iodine group and/or a bromine group is introduced into a copolymer elastomer having a ternary or binary copolymer composition of 50 to 80 mol % of vinylidene fluoride, 15 to 50 mol % of hexafluoropropylene, and 30 to 0 mol % of tetrafluoroethylene.

3. The peroxide crosslinkable fluororubber composition according to claim 1, wherein the processing aids (A) and (B) are used with their total amount being at a ratio of 0.5 to 3.0 parts by weight, based on 100 parts by weight of the peroxide crosslinkable fluororubber.

4. The peroxide crosslinkable fluororubber composition according to claim 1, wherein the sodium salt or potassium salt of a saturated or unsaturated higher fatty acid is a sodium salt or potassium salt of a saturated or unsaturated higher fatty acid, having 8 to 18 carbon atoms.

5. The peroxide crosslinkable fluororubber composition according to claim 4, wherein the higher fatty acid is a higher fatty acid derived from oils and fats.

6. The peroxide crosslinkable fluororubber composition according to claim 1, wherein the poly-α-olefin oligomer is an oligomer of α-olefin having 3 or more carbon atoms.

7. The peroxide crosslinkable fluororubber composition according to claim 1, which is used as a molding material for sealing material.

8. A sealing material obtained by crosslinking and molding the peroxide crosslinkable fluororubber composition according to claim 7.
